(19) United States
(12) Patent Application Publication
(10) Pub. No.: US 2014/0343178 A1
(43) Pub. Date: Nov. 20, 2014

(54) METHOD FOR MANUFACTURING POROUS HOLLOW FIBER MEMBRANE

(71) Applicants: Yugo Mizokoshi, Otake-shi (JP); Masaki Kurashina, Otake-shi (JP); Toshinori Sumi, Otake-shi (JP)

(72) Inventors: Yugo Mizokoshi, Otake-shi (JP); Masaki Kurashina, Otake-shi (JP); Toshinori Sumi, Otake-shi (JP)

(73) Assignee: Mitsubishi Rayon Co., Ltd., Tokyo (JP)

(21) Appl. No.: 14/344,469

(22) PCT Filed: Sep. 14, 2012
(86) PCT No.: PCT/JP2012/073699

§ 371 Date: Mar. 12, 2014

(30) Foreign Application Priority Data
Sep. 15, 2011 (JP) 2011-201860
Sep. 15, 2011 (JP) 2011-201861

(51) Int. Cl. C08J 9/26

(52) U.S. Cl. CPC C08J 9/26; C08J 2201/0464
USPC 521/77

(57) ABSTRACT

The purpose of the present invention is to provide a method for manufacturing a porous hollow fiber membrane in which the amount of a hypochlorite used during pore forming agent removal treatment can be reduced and the facilities cost can be minimized, and in which the post-treatment waste liquid can be readily treated. This method for manufacturing a porous hollow fiber membrane has: coagulating a membrane forming material liquid containing a membrane forming resin and a pore forming agent by a coagulating liquid, to thereby form a porous hollow fiber membrane precursor; and
removing the porous hollow fiber membrane precursor impregnated at least with a liquid into contact with ozone gas in a vapor phase, to thereby decompose and remove the pore forming agent present in the membrane.

### TECHNICAL FIELD

The present invention relates to a manufacturing method of a porous hollow fiber membrane.

The present application claims priority to Japanese Patent Application No. 2011-201860 filed on Sep. 15, 2011 and Japanese Patent Application No. 2011-201861 filed on Sep. 15, 2011, the entire contents of which are incorporated herein by reference.

### BACKGROUND ART

In the fields of food industry, medicine, electronics and the like, a microfilter membrane, an ultrafiltration membrane, a reverse osmosis filtration membrane and the like employing a porous hollow fiber membrane are widely used for: concentration and collection of useful components; removal of unwanted components; water production; and the like. In manufacture of a porous hollow fiber membrane, a membrane forming material liquid in which a membrane forming resin (hydrophobic polymer) and a pore forming agent such as polyvinyl pyrrolidone (hydrophilic polymer) are dissolved in a solvent such as N,N-dimethylacetamide is coagulated by a coagulating liquid to thereby form a porous hollow fiber membrane precursor. Thereafter, the porous hollow fiber membrane precursor thus formed is dried after removing the solvent and the pore forming agent remaining therein. By sufficiently removing the pore forming agent remaining in the porous hollow fiber membrane precursor, a porous hollow fiber membrane having sufficient water filtration performance can be obtained.

As a method of removing the pore forming agent remaining in the porous hollow fiber membrane precursor, for example, a method of applying a hypochlorite such as sodium hypochlorite to the porous hollow fiber membrane precursor, decomposing the pore forming agent by heating, and then cleaning to remove the pore forming agent reduced in molecular weight by the decomposition has been known (Patent Document 1).

### CITATION LIST

### Patent Literature

Patent Document 1: Japanese Unexamined Patent Application Publication No. 2005-42074

### DISCLOSURE OF THE INVENTION

### Problems to be Solved by the Invention

However, in order to use a hypochlorite for decomposing and removing the pore forming agent, it is necessary to use a device employing a corrosion resistant material such as titanium that leads to an increase in a facility cost. In addition, since hypochlorite is high in persistency and needs to be neutralized by sodium thiosulfate before being disposed of, waste liquid disposal becomes complex.

The purpose of the present invention is to provide a method for manufacturing a porous hollow fiber membrane in which the amount of a hypochlorite used during the pore forming agent removal treatment can be reduced and the facility cost can be minimized, and in which the post-treatment waste liquid can be readily treated.

### Means for Solving the Problems

A manufacturing method of a porous hollow fiber membrane of the present invention includes: a step of coagulating a membrane forming material liquid containing a membrane forming resin and a pore forming agent by a coagulating liquid, to thereby form a porous hollow fiber membrane precursor; and

a removing step of bringing the porous hollow fiber membrane precursor impregnated at least with a liquid into contact with ozone gas in a vapor phase, to thereby decompose and remove the pore forming agent present in the membrane.

In the manufacturing method of a porous hollow fiber membrane of the present invention, the porous hollow fiber membrane precursor impregnated with an oxidizing agent, which is other than ozone, and the liquid can be brought into contact with the ozone gas in the vapor phase.

In addition, it is preferable that the oxidizing agent is sodium hypochlorite.

In addition, it is preferable that the oxidizing agent is hydrogen peroxide.

In addition, in the method for manufacturing the porous hollow fiber membrane of the present invention, it is preferable that the liquid is water.

### Effects of the Invention

According to a method for manufacturing a porous hollow fiber membrane of the present invention, the amount of a hypochlorite used during the pore forming agent removal treatment can be reduced and the facility cost can be minimized, and disposal of the waste liquid after the treatment is easy.

### BRIEF DESCRIPTION OF THE DRAWINGS

FIG. 1 is a schematic view illustrating steps of a method for manufacturing a porous hollow fiber membrane according to a first embodiment; and

FIG. 2 is a schematic view illustrating steps of a method for manufacturing a porous hollow fiber membrane according to a second embodiment.

### PREFERRED MODE FOR CARRYING OUT THE INVENTION

The method for manufacturing a porous hollow fiber membrane according to the present invention can be either a method for manufacturing a porous hollow fiber membrane having a porous membrane layer on the outside of a hollow reinforcing support body (described later), or a method for manufacturing a porous hollow fiber membrane having a hollow porous membrane layer without the reinforcing support body. Alternatively, the method for manufacturing a porous hollow fiber membrane according to the present invention can be either a method for manufacturing a porous hollow fiber membrane having a single-layered porous membrane layer, or a method for manufacturing a porous hollow fiber membrane having a multi-layered porous membrane layer.

### First Embodiment

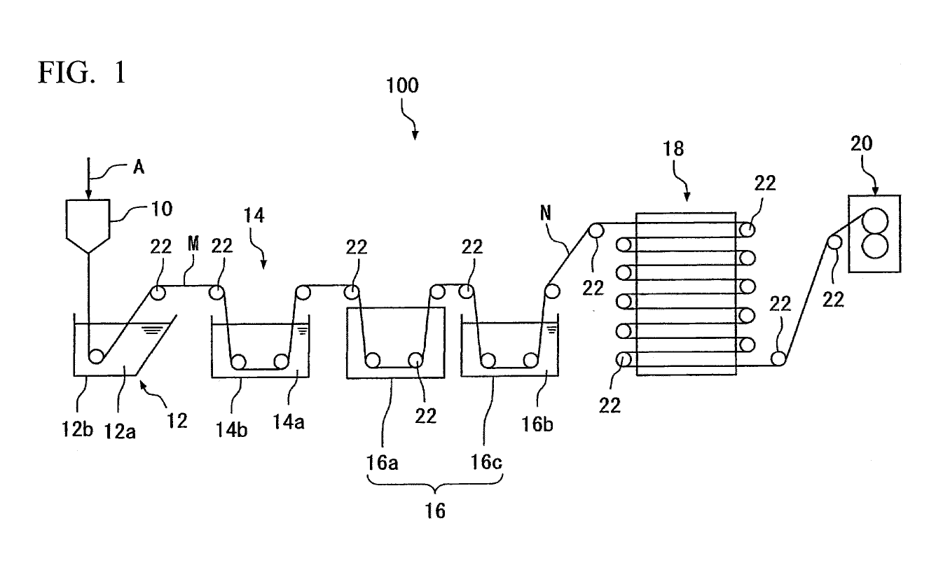

A method for manufacturing a porous hollow fiber membrane using a manufacturing apparatus 100 exemplified in FIG. 1 is described hereinafter as an example of the method for manufacturing a porous hollow fiber membrane according to the present application. The manufacturing apparatus 100 is an apparatus for manufacturing a porous hollow fiber membrane from a membrane forming material liquid containing a membrane forming resin, a pore forming agent, and a solvent.

As illustrate in FIG. 1, the manufacturing apparatus 100 includes a spinning nozzle 10, a coagulating means 12, a cleaning means 14, a removing means 16, a drying means 18, a winding means 20, and a plurality of guide members 22.

The spinning nozzle 10 is a nozzle that spins a membrane forming material liquid A.

The spinning nozzle 10 can be selected as appropriate according to a form of a porous hollow fiber membrane N to be manufactured. Either a spinning nozzle that discharges only the membrane forming material liquid A in a tubular shape in a single layer, or a spinning nozzle that discharges a plurality of kinds of the membrane forming material liquid A in a shape of concentric tubes in a multilayer configuration can be employed. Alternatively, a spinning nozzle that discharges the membrane forming material liquid A in such a way that the membrane forming material liquid A is applied to the outside of the hollow reinforcing support body (described later) can be employed.

The coagulating means 12 is a means for coagulating the membrane forming material liquid A spun by the spinning nozzle 10 by a coagulating liquid 12a, to thereby form a porous hollow fiber membrane precursor M.

The coagulating means 12 of the present example is configured such that the membrane forming material liquid A spun by the spinning nozzle 10 is immersed in the coagulating liquid 12a stored in a coagulation bath 12b, and the porous hollow fiber membrane precursor M formed by coagulation is withdrawn from the coagulating liquid 12a.

It is preferable that a temperature control means that can control the temperature of the coagulating liquid 12a is provided in the coagulation bath 12b.

The coagulating means 12 is not limited to this configuration. For example, a configuration of dropping the coagulating liquid 12a to make contact with the membrane forming material liquid A being spun, to thereby coagulate the membrane forming material liquid A, can be employed as the coagulating means 12.

In the present invention, either of: a dry-wet spinning method in which an idle running area is provided between the spinning nozzle 10 and the coagulating liquid 12a; and a wet spinning method in which the membrane forming material liquid is directly injected from the spinning nozzle 10 into the coagulating liquid 12a can be employed.

The cleaning means 14 is a means for cleaning and removing the solvent remaining in the porous hollow fiber membrane precursor M formed by the coagulating means 12.

The cleaning means 14 of the present example is configured to clean the porous hollow fiber membrane precursor M by causing the porous hollow fiber membrane precursor M to travel in the cleaning liquid 14a stored in a cleaning bath 14b.

The cleaning means 14 is not limited to this configuration. For example, a configuration of dropping the cleaning liquid 14a to make contact with the porous hollow fiber membrane precursor M travelling, to thereby clean the porous hollow fiber membrane precursor M, can be employed as the cleaning means 14.

The removing means 16 is a means for bringing the porous hollow fiber membrane precursor M impregnated with a liquid, during cleaning by the cleaning means 14, into contact with ozone gas in a vapor phase, to thereby decompose and remove the pore forming agent remaining in the membrane. By decomposing and removing the pore forming agent remaining in the membrane, the porous hollow fiber membrane N is formed.

The removing means 16 of the present example includes an ozone processing unit 16a and a cleaning bath 16c.

The ozone processing unit 16a is a unit for bringing the porous hollow fiber membrane precursor M impregnated with a liquid into contact with ozone gas in a vapor phase, to thereby decompose the pore forming agent remaining in the membrane. The cleaning bath 16c is a unit for cleaning the porous hollow fiber membrane precursor M with a cleaning liquid 16b to remove the pore forming agent reduced in molecular weight by the decomposition by the ozone processing unit 16a.

The ozone processing unit 16a is configured such that ozone gas is supplied thereinto and the porous hollow fiber membrane precursor M impregnated with the liquid passes through the ozone gas. The porous hollow fiber membrane precursor M that passes through the ozone gas is in a state of being impregnated with the liquid as a result of the cleaning by the cleaning means 14. The ozone gas that is brought into contact is absorbed by the liquid included in the porous hollow fiber membrane precursor M to form an ozone solution, and decompose the pore forming agent in the membrane by exhibiting an oxidizing power.

It is preferable that the ozone processing unit 16a is configured such that a water-saturated gas is supplied thereinto along with the ozone gas. This can prevent vaporization of the liquid included in the porous hollow fiber membrane precursor M travelling in the ozone processing unit 16a, to thereby improve ozone decomposition efficiency with respect to the pore forming agent.

It is preferable that the removing means 16 is provided with a heating means that heats the porous hollow fiber membrane precursor M travelling in the ozone processing unit 16a. As the heating means, a means of heating by a heated gas saturated with water and a means of heating by microwaves are preferable, from a viewpoint of prevention of vaporization of the liquid included in the porous hollow fiber membrane precursor M, to thereby improve ozone decomposition efficiency of the pore forming agent.

The pore forming agent reduced in molecular weight as a result of decomposition by the ozone processing unit 16a in the membrane is removed from the porous hollow fiber membrane precursor M by cleaning in the cleaning bath 16c storing the cleaning liquid 16b. By removing the pore forming agent from the porous hollow fiber membrane precursor M, the porous hollow fiber membrane N is obtained.

The number of the cleaning bath 16c is not limited to 1. It is preferable to provide two depressurizing cleaning baths that depressurize the outside of the porous hollow fiber membrane precursor M in the cleaning liquid 16b and a pressurizing cleaning bath that pressurizes the outside of the porous hollow fiber membrane precursor M in the cleaning liquid 16b, arranged in series in an order of: the depressurizing cleaning bath; the pressurizing cleaning bath; and the depressurizing cleaning bath. In this case, the cleaning liquid 16b infiltrates from the outside to the inside of the porous hollow fiber membrane precursor M in the pressurizing cleaning bath. In addition, the cleaning liquid 16b having infiltrated into the membrane in the pressurizing cleaning bath is discharged from the porous hollow fiber membrane precursor M in the depressurizing cleaning baths on both sides of the pressurizing cleaning bath. By thus arranging the depressurizing cleaning bath, the pressurizing cleaning bath, and the depressurizing cleaning bath in series, removal efficiency of the pore forming agent from the porous hollow fiber membrane precursor is improved.

The drying means 18 is a means for drying the porous hollow fiber membrane N obtained by removing the pore forming agent from the porous hollow fiber membrane precursor M.

As the drying means 18, any means that can sufficiently dry the porous hollow fiber membrane N can be employed. For example, a well-known drying device such as a hot air dryer, which is generally used for drying of a porous hollow fiber membrane, can be employed as the drying means 18. The drying means 18 of the present example is configured to dry the porous hollow fiber membrane N from the outside, by causing the porous hollow fiber membrane N to travel back and forth for a plurality of times in a device that can circulate hot air at a wind speed of several meters per second.

The winding means 20 is a means for winding the porous hollow fiber membrane N thus dried.

As the winding means 20, any means that can wind the porous hollow fiber membrane N around a bobbin or the like can be employed. As the winding means 20, a means configured to control the tensile strength of the porous hollow fiber membrane N by a tension roller, a torque motor and the like, and to wind the porous hollow fiber membrane N in such a manner that the porous hollow fiber membrane N traverses a guide or a bobbin can be exemplified.

The plurality of guide members 22 restricts travel of the porous hollow fiber membrane precursor M and the porous hollow fiber membrane N in the manufacturing apparatus 100. By providing the guide members 22, drooling can be prevented and the porous hollow fiber membrane precursor M and the porous hollow fiber membrane N can be prevented from being in contact with the inside, outside, and the vicinities of inlet and outlet of the means.

As the guide members 22, a member generally used for manufacture of a porous hollow fiber membrane can be employed, and a guide member made of metal or ceramic and the like can be exemplified.

### [Method for Manufacturing Porous Hollow Fiber Membrane]

The manufacturing method of a porous hollow fiber membrane using the manufacturing apparatus 100 includes a spinning and coagulation step, a cleaning step, a removing step, a drying step, and a winding step as described below.

Spinning and coagulating step: To spin the membrane forming material liquid A containing the membrane forming resin and the pore forming agent by the spinning nozzle 10, and to coagulate the membrane forming material liquid A by a coagulating liquid 12a, to thereby form the porous hollow fiber membrane precursor M.

Cleaning step: To clean and remove the solvent remaining in the porous hollow fiber membrane precursor M by the cleaning means 14.

Removing Step: To bring the porous hollow fiber membrane precursor M impregnated with a liquid into contact with ozone gas in a vapor phase by the removing means 16, to thereby decompose and remove the pore forming agent remaining in the membrane.

Drying step: To dry the porous hollow fiber membrane N obtained in the removing step by the drying means 18.

Winding step: To wind the porous hollow fiber membrane N after the drying, by the winding means 20.

### (Spinning and Coagulation Step)

The membrane forming material liquid A containing the membrane forming resin (hydrophobic polymer) and the pore forming agent (hydrophilic polymer) and the solvent is spun from the spinning nozzle 10. Thereafter, the membrane forming material liquid A thus spun is coagulated by immersing in the coagulating liquid 12a stored in the coagulation bath 12b, to thereby form the porous hollow fiber membrane precursor M.

By immersing the membrane forming material liquid A discharged from the spinning nozzle 10 in the coagulating liquid 12a, the coagulating liquid 12a diffuses in the membrane forming material liquid A, causing phase separation and coagulation of the membrane forming resin and the pore forming agent. As a result, the porous hollow fiber membrane precursor M is formed having a porous membrane layer with a three dimensional net-like structure in which the membrane forming resin and the pore forming agent are alternately interlaced. In this stage, the pore forming agent is supposed to interlace with the membrane forming resin in a three-dimensional way in a gel state.

As the membrane forming resin, a general resin that is used for forming a porous membrane layer of the porous hollow fiber membrane can be employed. As the membrane forming resin, for example, polyether sulfone resin, sulfonated polysulfone resin, polyvinylidene fluoride resin, polyimide resin, polyamide imide resin, polyester imide resin, polyvinyl chloride resin, chlorinated polyvinyl chloride resin can be exemplified. These membrane forming resins can be selected and employed as appropriate, as required. Among these, polyvinylidene fluoride resin, which is superior in chemical resistance, is preferred as the membrane forming resin.

The membrane forming resin can be used singly or in combination of two or more.

For example, opening agents include high polymer resin such as polyethylene glycol, polyvinyl alcohol, and polyvinylpyrrolidone. As the pore forming agent, polymeric resins such as polyethylene glycol, polyvinyl alcohol, and polyvinyl pyrrolidone can be exemplified. As the pore forming agent, polyvinyl pyrrolidone, which facilitates control of membrane structure of the porous hollow fiber membrane to be manufactured, is preferable.

The pore forming agent can be used singly or in combination of two or more.

The solvent is not particularly limited as long as it can dissolve both of the membrane forming resin and the pore forming agent. As the solvent, dimethyl sulfoxide, N,N-dimethylacetamide, dimethylformamide, and N-methyl-2-pyrrolidone can be exemplified.

The solvent can be used singly or in combination of two or more.

It should be noted that the membrane forming material liquid can include an additive other than the pore forming agent as an optional component, in such a range as not to encumber control of phase separation.

The content of the membrane forming resin in the membrane forming material liquid A (100 mass %) is preferably at least 10 mass % and more preferably at least 15 mass %, from the viewpoint of facilitating formation of a superior porous membrane structure. The content of the membrane forming resin is preferably no greater than 30 mass % and more preferably no greater than 25 mass %, for the same reason.

The content of the pore forming agent in the membrane forming material liquid A (100 mass %) is preferably at least 1 mass % and more preferably at least 5 mass %, from the viewpoint of facilitating formation of a porous hollow fiber membrane. The content of the pore forming agent is preferably no greater than 20 mass % and more preferably no greater than 12 mass %, from the viewpoint of handling of the membrane forming material liquid.

The temperature of the membrane forming material liquid A is preferably 20 to 40° C.

In the method for manufacturing the porous hollow fiber membrane of the present invention, the porous hollow fiber membrane N can be formed in which the porous membrane layer is formed on the outside of the hollow reinforcing support body, in order to obtain a porous hollow fiber membrane having superior strength.

As the hollow reinforcing support body, a hollow knitted or braided string made of various kinds of fiber can be exemplified. For the hollow reinforcing support body, various materials can be used singly or in combination. As fiber used for the hollow knitted or braided string, synthetic fiber, semisynthetic fiber, recycled fiber, natural fiber and the like can be exemplified. The fiber can be in the form of any of a monofilament, a multifilament or a spun yarn.

The coagulating liquid 12a is required to be a solvent that does not dissolve the membrane forming resin and a good solvent of the pore forming agent. Water, ethanol, methanol or the like, and a mixture thereof can be exemplified as the coagulating liquid 12a. Particularly, a liquid mixture of the solvent used in the membrane forming material liquid A and water is preferable in view of working environment and operational management.

The temperature of the coagulating liquid 12a is preferably 60 to 90° C.

### (Cleaning Step)

In the porous hollow fiber membrane precursor M formed in the spinning and coagulating step, the pore forming agent and the solvent remain in a state of solution. The porous hollow fiber membrane precursor M with the pore forming agent remaining in the membrane cannot provide sufficient water filtration performance. In addition, if the pore forming agent exsiccates in the membrane, the mechanical strength of the porous hollow fiber membrane precursor M decreases. Meanwhile, if the pore forming agent remains in the porous hollow fiber membrane upon oxidative decomposition (reduction in molecular weight) of the pore forming agent in the removing step (described later), the solvent reacts with ozone, leading to reduction in decomposition efficiency of the pore forming agent. Given this, in the present embodiment, after the spinning and coagulating step, the solvent remaining in the porous hollow fiber membrane precursor M is removed in the cleaning step and then the pore forming agent remaining in the porous hollow fiber membrane precursor M is removed in the removing step.

In the cleaning step, the porous hollow fiber membrane precursor M is cleaned by the cleaning means 14 with the cleaning liquid 14a, to thereby remove the solvent remaining in the porous hollow fiber membrane precursor M. The solvent in the porous hollow fiber membrane precursor M diffuses and moves from the inside of the membrane toward the surface of the membrane, and then from the surface of the membrane to the cleaning liquid 14a, and is thus removed from the porous hollow fiber membrane precursor M.

As the cleaning liquid 14a, water is preferable for a superior cleaning effect. As the water to be used, tap water, industrial water, river water, well water, and the like can be exemplified. In addition, a solution obtained by blending the water with alcohol, inorganic salts, an oxidizing agent, a surfactant and the like can also be used as the cleaning liquid 14a. Furthermore, a liquid mixture of water and the solvent included in the membrane forming material liquid A can also be used as the cleaning liquid 14a. In a case of using the liquid mixture, the content of the solvent is preferably no greater than 10 mass %.

The temperature of the cleaning liquid 14a is preferably no lower than 50° C. and more preferably no lower than 80° C. The temperature of the cleaning liquid 14a of at least the lower limit improves the diffusional moving speed of the solvent remaining in the porous hollow fiber membrane precursor M.

In the cleaning step, the solvent in the porous hollow fiber membrane precursor M is mainly removed; however, as the porous hollow fiber membrane precursor M is cleaned, the pore forming agent in the membrane is partially removed.

### (Removing Step)

In the removing step, by the removing means 16, the porous hollow fiber membrane precursor M impregnated with a liquid is brought into contact with ozone gas in a vapor phase, to thereby decompose the pore forming agent remaining in the membrane and remove the pore forming agent thus reduced in molecular weight by the decomposition from the porous hollow fiber membrane precursor M. More specifically, the porous hollow fiber membrane precursor M including the liquid as a result of cleaning by the cleaning means 14 passes through the ozone gas supplied to the inside of the ozone processing unit 16a. By thus bringing the porous hollow fiber membrane precursor M including the liquid with the ozone gas, the ozone gas is absorbed by the liquid included in the porous hollow fiber membrane precursor M. The ozone gas absorbed by the liquid forms an ozone solution in the membrane, and the ozone solution decomposes the pore forming agent in the porous hollow fiber membrane precursor M.

The half life of the ozone concentration in the ozone solution is short. For example, in ozone water, the half life of the ozone concentration is approximately 20 minutes. Therefore, in the ozone solution, it is difficult to increase the ozone concentration and to maintain sufficient decomposing performance for a long period of time. However, the present invention does not employ a pre-made ozone solution but uses the ozone gas that is more stable than the ozone solution to form an ozone solution in the membrane of the porous hollow fiber membrane precursor M. As a result, the present invention can develop the sufficient decomposing performance of ozone with respect to the pore forming agent, and can thus efficiently remove the pore forming agent in the porous hollow fiber membrane precursor.

As the liquid to impregnate the porous hollow fiber membrane precursor M in the removing step, water is preferable for easy handling and cost effectiveness.

It should be noted that the liquid to impregnate the porous hollow fiber membrane precursor M is not limited to water. For example in a case of employing the removing means provided with a liquid supply unit on an upstream side of the ozone processing unit 16a to newly supply the liquid to the porous hollow fiber membrane precursor after the cleaning, the porous hollow fiber membrane precursor M can be impregnated with a liquid other than the cleaning liquid used in the cleaning step.

As the liquid other than the cleaning liquid, any liquid that can dissolve ozone can be used. As the liquid other than the cleaning liquid, for example, acetic acid can be exemplified.

The ozone concentration of the ozone gas used in the removing step is preferably at least 0.5 vol % and more preferably at least 2.5 vol %, from the viewpoint of improvement of ozone decomposition efficiency with respect to the pore forming agent. In addition, the ozone concentration of the ozone gas used is preferably no greater than 10 vol % from the viewpoint of the lower explosion limit of the ozone gas.

A relative humidity of the atmosphere upon contact of the porous hollow fiber membrane precursor M with the ozone gas can be in such a degree that the liquid included in the porous hollow fiber membrane precursor M does not evaporate and dry. The humidity of the atmosphere depends on a duration of stay of the porous hollow fiber membrane precursor M in the atmosphere and a volume of the apparatus. In addition, it is difficult to control the level of humidity in a state except for a saturated state. Given this, it is preferable to bring the porous hollow fiber membrane precursor M into contact with the ozone gas in an atmosphere in which water is saturated (100% relative humidity). This can prevent vaporization of the liquid included in the porous hollow fiber membrane precursor M and allow more stable generation of ozone water in the membrane, to thereby improve ozone decomposition efficiency with respect to the pore forming agent.

Upon the ozone decomposition of the pore forming agent remaining in the membrane by bringing the porous hollow fiber membrane precursor M with the ozone gas, it is preferable to bring the porous hollow fiber membrane precursor M with the water-saturated gas along with the ozone gas. This can further prevent vaporization of the liquid included in the porous hollow fiber membrane precursor M and allow more stable generation of ozone solution in the membrane, to thereby improve ozone decomposition efficiency with respect to the pore forming agent.

The lower limit of the temperature of the porous hollow fiber membrane precursor M upon ozone decomposition of the pore forming agent is preferably 30° C. and more preferably 50° C., from the viewpoint of reactivity of the pore forming agent to the ozone decomposition. The upper limit of the temperature of the porous hollow fiber membrane precursor M is preferably a temperature that does not cause evaporation of the liquid included in the porous hollow fiber membrane precursor M under atmospheric pressure. For example, in a case in which the porous hollow fiber membrane precursor M is impregnated with water, the upper limit of the temperature of the porous hollow fiber membrane precursor M is preferably 100° C.

In a configuration of heating the porous hollow fiber membrane precursor under atmospheric pressure, even in a case of consecutively processing the travelling porous hollow fiber membrane precursors, no special sealing device is required at the inlet and outlet for the porous hollow fiber membrane precursor in the ozone processing unit 16a, and no pressure resistant structure is required for the apparatus main body. Therefore, the apparatus has a great advantage and superior operability.

As a method for heating the porous hollow fiber membrane precursor M, a method of heating by bringing water-saturated gas heated to a predetermined temperature into contact with the porous hollow fiber membrane precursor M, and a method of heating by irradiating the porous hollow fiber membrane precursor M with microwaves are preferable. These methods can suppress evaporation of the liquid included in the porous hollow fiber membrane precursor M due to heating.

In a case of heating the porous hollow fiber membrane precursor M by employing the water-saturated gas, it is more preferable to employ saturated vapor, which can rapidly elevate the temperature of the porous hollow fiber membrane precursor M. In a case of heating the porous hollow fiber membrane precursor M by employing microwaves, it is preferable to set the irradiation time within such a range that the liquid included in the porous hollow fiber membrane precursor M does not completely evaporate.

Ozone gas processing time for the porous hollow fiber membrane precursor M depends on conditions such as the temperature of the porous hollow fiber membrane precursor M and the ozone concentration of the ozone gas; however, preferably 3 to 15 minutes and more preferably 5 to 10 minutes. The processing time of at least the lower limit allows sufficient decomposition and removal of the pore forming agent remaining in the porous hollow fiber membrane precursor M. The processing time no greater than the upper limit improves productivity of the porous hollow fiber membrane N. Here, the ozone gas processing time is a duration of contact between the porous hollow fiber membrane precursor and the ozone gas.

As a method for removing the pore forming agent, which has been reduced in molecular weight by the decomposition, from the porous hollow fiber membrane precursor M, a method of cleaning the porous hollow fiber membrane precursor M with the cleaning liquid 16b as in the present example is preferable. In addition, as a method for removing the pore forming agent from the porous hollow fiber membrane precursor, a method of: arranging the depressurizing cleaning bath, the pressurizing cleaning bath, and the depressurizing cleaning bath in series; causing the cleaning liquid 16b to infiltrate from the outside to the inside of the porous hollow fiber membrane precursor in the pressurizing cleaning bath; and discharging the cleaning liquid 16b having infiltrated into the membrane from the porous hollow fiber membrane precursor in the depressurizing cleaning baths on both sides of the pressurizing cleaning bath, as described above, is preferable. As a result, the pore forming agent reduced in molecular weight can be removed from the porous hollow fiber membrane precursor more efficiently.

It should be noted that the method for removing the pore forming agent from the porous hollow fiber membrane precursor is not limited to the above described method, as long as the pore forming agent reduced in molecular weight can be sufficiently removed.

As the cleaning liquid 16b, the same liquid exemplified as the cleaning liquid 14a can be used.

### (Drying Step)

The porous hollow fiber membrane N is dried by the drying means 18.

As a method for drying the porous hollow fiber membrane N, a method generally employed for drying porous hollow fiber membranes can be employed. As a method for drying the porous hollow fiber membrane N, a hot air drying method of drying the porous hollow fiber membrane N with hot air can be exemplified. More specifically, a method of drying the porous hollow fiber membrane N from the outside, by causing the porous hollow fiber membrane N to travel back and forth for a plurality of time in a device that can circulate hot air at a wind speed of several meters per second can be exemplified.

### (Winding Step)

The porous hollow fiber membrane N is wound after the drying, by the winding means 20.

As described above, hypochlorite such as sodium hypochlorite is widely used in the conventional method for decomposing and removing the pore forming agent. However, in such a method, it is necessary to use a device employing a corrosion resistant material such as titanium that leads to an increase in the facility cost. In addition, since a process such as neutralization is required upon disposal, waste liquid disposal becomes complex.

On the other hand, in the removing step in the method for manufacturing a porous hollow fiber membrane according to the present embodiment, the ozone gas is used for decomposition and removal of the pore forming agent, and no other oxidizing agent than ozone, such as hypochlorite, is used. Ozone does not corrode an SUS (stainless steel) material and the like. As a result, there is no need to use a device employing a corrosion resistant material such as titanium and the equipment and facility costs can be minimized. In addition, a decomposition product of ozone is oxygen, which has a low environmental impact. As a result, a special process such as neutralization is not required upon disposal, making waste liquid disposal easy.

### Second Embodiment

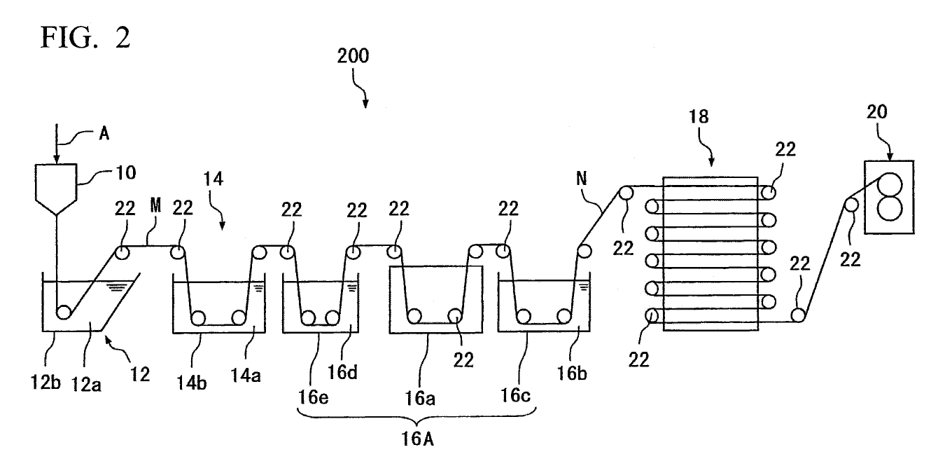

A method for manufacturing a porous hollow fiber membrane using a manufacturing apparatus 200 exemplified in FIG. 2 is described hereinafter as another example of the method for manufacturing a porous hollow fiber membrane according to the present application. The manufacturing apparatus 200 is an apparatus for manufacturing a porous hollow fiber membrane from a membrane forming material liquid containing a membrane forming resin, a pore forming agent, and a solvent. Components in FIG. 2 identical to those in FIG. 1 are denoted by the same reference numerals and descriptions thereof are omitted.

As illustrate in FIG. 2, the manufacturing apparatus 200 includes a spinning nozzle 10, a coagulating means 12, a cleaning means 14, a removing means 16, a drying means 18, a winding means 20, and a plurality of guide members 22. In other words, the manufacturing apparatus 200 is identical to the manufacturing apparatus 100 except for the removing means 16A instead of the removing means 16.

The removing means 16A is a means for bringing the porous hollow fiber membrane precursor M impregnated with at least an oxidizing agent which is other than ozone (hereinafter may be referred to as “other oxidizing agent”) and a liquid, into contact with ozone gas in a vapor phase, to thereby decompose and remove the pore forming agent remaining in the membrane.

The removing means 16A of the present example includes an oxidizing agent supply unit 16e, an ozone processing unit (pore forming agent decomposing unit) 16a, and a cleaning bath 16c.

The oxidizing agent supply unit 16e is a unit that supplies the other oxidizing agent and the liquid to the porous hollow fiber membrane precursor M. An oxidizing agent solution 16d containing the other oxidizing agent and the liquid is stored in the oxidizing agent supply unit 16e. By causing the porous hollow fiber membrane precursor M to travel in the oxidizing agent solution 16d stored in the oxidizing agent supply unit 16e, the other oxidizing agent and the liquid are supplied to the porous hollow fiber membrane precursor M.

The ozone processing unit 16a is identical to the ozone processing unit 16a in the manufacturing apparatus 100 except for that the porous hollow fiber membrane precursor M including the other oxidizing agent and the liquid travels therein. In the ozone processing unit 16a in the removing means 16A, the porous hollow fiber membrane precursor M impregnated with the other oxidizing agent and the liquid is brought into contact with ozone gas in a vapor phase. The ozone gas that is brought into contact with the porous hollow fiber membrane precursor M is absorbed by the liquid included in the porous hollow fiber membrane precursor M to form an ozone solution. The ozone solution exhibiting an oxidizing power and the other oxidizing agent decompose the pore forming agent remaining in the porous hollow fiber membrane precursor M.

The preferred configuration of the ozone processing unit 16a in the removing means 16A is similar to the preferred configuration of the ozone processing unit 16a in the removing means 16.

The cleaning bath 16c of the removing means 16A is identical to the cleaning bath 16c of the removing means 16. In the cleaning bath 16c, the porous hollow fiber membrane precursor M is cleaned with the cleaning liquid 16b to remove the pore forming agent reduced in molecular weight by the decomposition by the ozone processing unit 16a. The porous hollow fiber membrane N is thus obtained.

The preferred configuration of the cleaning bath 16c in the removing means 16A is similar to the preferred configuration of the cleaning bath 16c in the removing means 16.

### (Method for Manufacturing Porous Hollow Fiber Membrane)

The manufacturing method of a porous hollow fiber membrane using the manufacturing apparatus 200 includes a spinning and coagulation step, a cleaning step, a removing step, a drying step, and a winding step as described below.

Spinning and coagulating step: To spin the membrane forming material liquid A containing the membrane forming resin and the pore forming agent by the spinning nozzle 10, and to coagulate the membrane forming material liquid A by a coagulating liquid 12a, to thereby form the porous hollow fiber membrane precursor M.

Cleaning step: To clean and remove the solvent remaining in the porous hollow fiber membrane precursor M by the cleaning means 14.

Removing Step: To bring the porous hollow fiber membrane precursor M impregnated with at least the other oxidizing agent and the liquid into contact with ozone gas in a vapor phase by the removing means 16A, to thereby decompose and remove the pore forming agent remaining in the membrane.

Drying step: To dry the porous hollow fiber membrane N obtained in the removing step by the drying means 18.

Winding step: To wind the porous hollow fiber membrane N after the drying, by the winding means 20.

### (Spinning and Coagulation Step)

The spinning and coagulation step can be performed similarly to the spinning and coagulation step of the first embodiment.

Also in the method for manufacturing the porous hollow fiber membrane of the present embodiment, the porous hollow fiber membrane N can be formed in which the porous membrane layer is formed on the outside of the hollow reinforcing support body, in order to obtain a porous hollow fiber membrane having superior strength.

### (Cleaning Step)

The cleaning step can be performed similarly to the cleaning step of the first embodiment.

### (Removing Step)

In the removing step, by the removing means 16A, the porous hollow fiber membrane precursor M impregnated with at least the other oxidizing agent and water is brought into contact with ozone gas in a vapor phase, to thereby decompose the pore forming agent remaining in the membrane by the other oxidizing agent and ozone and remove the pore forming agent thus reduced in molecular weight by the decomposition from the porous hollow fiber membrane precursor M.

More specifically, by causing the porous hollow fiber membrane precursor M to travel in the oxidizing agent solution 16d stored in the oxidizing agent supply unit 16e, the porous hollow fiber membrane precursor M is impregnated with the other oxidizing agent and the liquid. Thereafter, the porous hollow fiber membrane precursor M including the other oxidizing agent and the liquid passes through the ozone gas supplied to the inside of the ozone processing unit 16a. By thus bringing the porous hollow fiber membrane precursor M including the other oxidizing agent and water with the ozone gas in the vapor phase, the ozone gas is absorbed by the liquid included in the porous hollow fiber membrane precursor M to form an ozone solution in the membrane. The ozone solution thus generated and the other oxidizing agent decompose the pore forming agent in the porous hollow fiber membrane precursor M.

The present embodiment does not employ a pre-made ozone solution but uses the ozone gas that is more stable than the ozone solution to form an ozone solution in the membrane of the porous hollow fiber membrane precursor M. As a result, the sufficient decomposing performance of ozone with respect to the pore forming agent can be developed, and the pore forming agent in the porous hollow fiber membrane precursor can thus be efficiently removed.

As the other oxidizing agent, for example, hypochlorite, chlorite, hydrogen peroxide, permanganate, bichromate, persulfate and the like can be exemplified. Among these, hypochlorite is preferable as the other oxidizing agent, in terms of oxidative power, decomposition performance, operability, cost, and the like.

As hypochlorite, sodium hypochlorite, calcium hypochlorite and the like can be exemplified. As hypochlorite, sodium hypochlorite is more preferable since decomposition efficiency with respect to the pore forming agent is high and the porous hollow fiber membrane having high water filtration performance can be obtained in a shorter period of time. In other words, a combination of sodium hypochlorite and the ozone gas is particularly preferable in terms of decomposition efficiency with respect to the pore forming agent.

Alternatively, hydrogen peroxide is preferably used as the other oxidizing agent, since the porous hollow fiber membrane having high water filtration performance can be obtained in a short period of time, and it is not necessary to use a device employing a corrosion resistant material such as titanium, allowing substantial reduction in the facility cost. In other words, a combination of hydrogen peroxide and the ozone gas is particularly preferable in terms of reduction of cost.

As the liquid with which the porous hollow fiber membrane precursor M is impregnated, any liquid that can dissolve ozone can be used. Water, acetic acid and the like can be exemplified as the liquid. Among these, water is preferable as the liquid with which the porous hollow fiber membrane precursor M is impregnated, for easy handling and cost effectiveness.

The content of the other oxidizing agent in the oxidizing agent solution 16d can be set as appropriate according to the type of the other oxidizing agent.

For example, in a case of employing sodium hypochlorite as the other oxidizing agent, the content of sodium hypochlorite in the oxidizing agent solution 16d is preferably at least 0.3 mass % and more preferably at least 3.0 mass %. The content of sodium hypochlorite of at least the lower limit can improve decomposition efficiency of sodium hypochlorite with respect to the pore forming agent. In addition, the content of sodium hypochlorite in the oxidizing agent solution 16d is no greater than 12 mass % and more preferably no greater than 10 mass %. The content of sodium hypochlorite of no greater than the upper limit facilitates neutralization process of sodium hypochlorite remaining in waste liquid.

Alternatively, in a case of employing hydrogen peroxide as the other oxidizing agent, the content of hydrogen peroxide in the oxidizing agent solution 16d is preferably at least 1.0 mass % and more preferably at least 3.0 mass %. The content of hydrogen peroxide of at least the lower limit can improve decomposition efficiency of hydrogen peroxide with respect to the pore forming agent. In addition, the content of hydrogen peroxide is preferably no greater than 60 mass % and more preferably no greater than 30 mass %, in terms of easy handling.

The temperature of the oxidizing agent solution 16d is preferably no higher than 50° C. and more preferably no higher than 30° C. The temperature of the oxidizing agent solution 16d of no greater than the upper limit can prevent the pore forming agent remaining in the porous hollow fiber membrane precursor M from leaking into the oxidizing agent solution 16d and being oxidatively decomposed, wasting the other oxidative agent. The temperature of the oxidizing agent solution 16d is preferably at least 0° C. and more preferably at least 10° C. The temperature of the oxidizing agent solution 16d of at least the lower limit can minimize cost for controlling the oxidizing agent solution 16d at a low temperature.

The ozone concentration of the ozone gas used in the removing step is preferably at least 0.5 vol % and more preferably at least 2.5 vol %, from the viewpoint of improvement of ozone decomposition efficiency with respect to the pore forming agent. In addition, the ozone concentration of the ozone gas used is preferably no greater than 10 vol % from the viewpoint of the lower explosion limit of the ozone gas.

For the same reason as in the first embodiment, it is preferable to bring the porous hollow fiber membrane precursor M into contact with the ozone gas in an atmosphere in which water is saturated (100% relative humidity). When bringing the porous hollow fiber membrane precursor M into contact with the ozone gas, it is preferable to bring the porous hollow fiber membrane precursor M into contact with the water-saturated gas along with the ozone gas.

The lower limit of the temperature of the porous hollow fiber membrane precursor M upon ozone decomposition of the pore forming agent is preferable 30° C. and more preferably 60° C., from the viewpoint of reactivity of the pore forming agent to the ozone decomposition. The temperature of the porous hollow fiber membrane precursor M of at least the lower limit can accelerate the decomposition speed of the pore forming agent. The upper limit of the temperature of the porous hollow fiber membrane precursor M is preferably a temperature that does not cause evaporation of the liquid included in the porous hollow fiber membrane precursor M under atmospheric pressure. For example, in a case in which the porous hollow fiber membrane precursor M is impregnated with water, the upper limit of the temperature of the porous hollow fiber membrane precursor M is preferably 100° C.

In a configuration of heating the porous hollow fiber membrane precursor under atmospheric pressure, even in a case of consecutively processing the travelling porous hollow fiber membrane precursors, no special sealing device is required at the inlet and outlet for the porous hollow fiber membrane precursor in the ozone processing unit 16a, and no pressure resistant structure is required for the apparatus main body. Therefore, the apparatus has a great advantage and superior operability.

As a method for heating the porous hollow fiber membrane precursor M, a method of heating by bringing water-saturated gas heated to a predetermined temperature into contact with the porous hollow fiber membrane precursor M is preferable. This method can suppress evaporation of the liquid included in the porous hollow fiber membrane precursor M due to heating. In a case of heating the porous hollow fiber membrane precursor M by employing the water-saturated gas, it is more preferable to employ saturated vapor, which can rapidly elevate the temperature of the porous hollow fiber membrane precursor M.

In a case in which the other oxidizing agent is hypochlorite, pH of the porous hollow fiber membrane precursor M including hypochlorite and water is preferably no greater than 13.5 and more preferably no greater than 11.0. pH of the porous hollow fiber membrane precursor M of no greater than the upper limit facilitates manufacture of a porous hollow fiber membrane having superior water filtration performance. In addition, pH of the porous hollow fiber membrane precursor M is preferably at least 7. pH of the porous hollow fiber membrane precursor M of at least the lower limit facilitates suppression of generation of chlorine gas from the hypochlorite due to drop in pH.

Processing time of the porous hollow fiber membrane precursor M by the other pore forming agent and ozone gas (time of travel of the porous hollow fiber membrane precursor M in the ozone processing unit 16a) depends on conditions such as the temperature of the porous hollow fiber membrane precursor M and the ozone concentration of the ozone gas; however, preferably 0.5 to 10 minutes and more preferably 1 to 5 minutes. The processing time of at least the lower limit facilitates sufficient decomposition and removal of the pore forming agent remaining in the porous hollow fiber membrane precursor M. In addition, the processing time of no greater than the upper limit improves productivity of the porous hollow fiber membrane N.

As a method for removing the pore forming agent, which has been reduced in molecular weight by the decomposition, from the porous hollow fiber membrane precursor M, a method of cleaning the porous hollow fiber membrane precursor M with the cleaning liquid 16b is preferable for the same reason as in the first embodiment. More preferable is a method of: arranging the depressurizing cleaning bath, the pressurizing cleaning bath, and the depressurizing cleaning bath in series; causing the cleaning liquid 16b to infiltrate from the outside to the inside of the porous hollow fiber membrane precursor in the pressurizing cleaning bath; and discharging the cleaning liquid 16b having infiltrated into the membrane from the porous hollow fiber membrane precursor in the depressurizing cleaning baths on both sides of the pressurizing cleaning bath.

It should be noted that the method for removing the pore forming agent from the porous hollow fiber membrane precursor is not limited to the above described method, as long as the pore forming agent reduced in molecular weight can be sufficiently removed.

As the cleaning liquid 16b, the same liquid exemplified as the cleaning liquid 14a of the first embodiment can be used.

### (Drying Step)

The drying step can be performed similarly to the drying step of the first embodiment.

### (Winding Step)

The porous hollow fiber membrane N is wound after the drying, by the winding means 20.

In the removing step in the method for manufacturing the porous hollow fiber membrane of the present embodiment, the pore forming agent remaining in the porous hollow fiber membrane precursor is decomposed and removed by a combination of ozone and other oxidizing agent such as hypochlorite. The pore forming agent can thus be decomposed and removed with particularly superior decomposition efficiency, compared to a case of using ozone or other oxidizing agent singly. As a result, the porous hollow fiber membrane having sufficient water filtration performance can be obtained in a shorter period of time. Given this, in the method for manufacturing the porous hollow fiber membrane of the present embodiment, equipment for decomposing and removing the pore forming agent can be reduced in size, allowing a reduction in equipment and facility costs.

In addition, ozone which does not corrode an SUS (stainless steel) material and the like is employed in the present embodiment, the amount of the other oxidizing agent used can be reduced compared to a case of using the other oxidizing agent singly. Special equipment is not necessarily required since corrosion of devices can be suppressed even in a case of using hypochlorite or the like. Given this, in the method for manufacturing the porous hollow fiber membrane of the present embodiment can realize further reduction in the equipment and facility costs. Especially, using hydrogen peroxide eliminates the need of equipment employing a titanium material and the like, and can realize substantial reduction in the equipment and facility costs.

In addition, since a decomposition product of ozone is oxygen which has a low environmental impact, no special process such as neutralization is required for the waste liquid after the process. In addition, using ozone reduces the amount of the other oxidizing agent such as hypochlorite and hydrogen peroxide used, and facilitates disposal of the waste liquid.

### OTHER EMBODIMENTS

It should be noted that the method for manufacturing the porous hollow fiber membrane of the present invention is not limited to a method employing the above described manufacturing apparatus 100 or the manufacturing apparatus 200, as long as the method includes a removing step of bringing the porous hollow fiber membrane precursor impregnated at least with a liquid into contact with ozone gas in a vapor phase, to thereby decompose and remove the pore forming agent present in the membrane.

For example, the method for manufacturing the porous hollow fiber membrane of the present invention can be a method repeating a removing step of decomposing and removing the pore forming agent, to the extent that the effect of the present invention is not impaired. In this case, a first removing step among the plurality of removing steps is preferably a removing step of bringing a porous hollow fiber membrane precursor impregnated at least with a liquid into contact with ozone gas in a vapor phase, to thereby decompose and remove a pore forming agent present in the membrane. The remaining removing steps can be well-known removing steps of decomposing and removing the pore forming agent using an oxidizing agent, to the extent that the effect of the present invention is not impaired.

Also in this case, using ozone can reduce the amount of a hypochlorite used during the pore forming agent removal treatment to minimize equipment and facility costs, and can facilitate disposal of the waste liquid.

In addition, the method for manufacturing the porous hollow fiber membrane of the present invention can be a method without the cleaning step preceding the removing step.

In the method for manufacturing the porous hollow fiber membrane of the present invention in which the other oxidizing agent is not employed in the removing step, in a case in which the porous hollow fiber membrane precursor does not include sufficient liquid before the removing step (for example in a case in which no cleaning step takes place), it is preferable to immerse to sufficiently impregnate the porous hollow fiber membrane precursor with liquid before bringing the porous hollow fiber membrane precursor into contact with ozone gas in the removing step. In the method for manufacturing the porous hollow fiber membrane of the present invention, another preferred mode of the removing step in a case in which no cleaning step takes place before the removing step is the same as the preferred mode of the removing step in a case in which the cleaning step takes place before the removing step.

In the method for manufacturing the porous hollow fiber membrane of the present invention in which no other oxidizing agent is used in the removing step, in a case in which the liquid with which the porous hollow fiber membrane precursor is impregnated is water, the porous hollow fiber membrane precursor can be impregnated with water by supplying water vapor therearound.

In addition, in the method for manufacturing the porous hollow fiber membrane of the present invention in which the other oxidizing agent is used, an oxidizing agent solution containing the other oxidizing agent, the liquid, and ozone can be used and the porous hollow fiber membrane precursor including the other oxidizing agent, the liquid, and ozone can be brought into contact with ozone gas in the vapor phase.

In addition, the method for manufacturing the porous hollow fiber membrane of the present invention can be a method without the drying step.

In addition, the method for manufacturing the porous hollow fiber membrane of the present invention can be a method without the winding step.

In addition, the method for manufacturing the porous hollow fiber membrane of the present invention can be a method in which the above described steps take place sequentially, not continuously.

The present invention is described in detail hereinafter by way of Examples; however, the present invention is not limited to the following description.

### Example 1

A membrane forming material liquid (1) and a membrane forming material liquid (2) were prepared by: blending polyvinylidene fluoride A (manufactured by ATOFINA JAPAN, product name: KYNAR301F), polyvinylidene fluoride B (manufactured by ATOFINA JAPAN, product name: KYNAR9000LD), polyvinylpyrrolidone (manufactured by ISP, product name: K-90) and N,N-dimethylacetamide in the mass ratio shown in Table 1, respectively, and degassing.

TABLE 1

| | Membrane Forming | Membrane Forming |
|---|---|---|
| Composition | Material Liquid (1) | Material Liquid (2) |
| Polyvinylidene fluoride A | 19 | 12 |
| Polyvinylidene fluoride B | 0 | 12 |
| Polyvinylpyrrolidone | 10 | 11 |
| N,N-dimethylacetamide | 71 | 65 |
| Material Liquid Temperature | 60° C. | 60° C. |
| Polyvinylidene fluoride | 19 mass % | 24 mass % |
| concentration in material | | |
| liquid | | |

A nozzle with a hollow part in the center and three annular injection openings provided successively on the outside thereof, in order to apply and layer the two membrane forming material liquids was used. In a state in which the nozzle was maintained at 30° C., a polyester multifilament single fiber knitted string (multifilament; 420 T/180 F) as the reinforcing support body was introduced into the hollow part, while applying the membrane forming material liquid (2) and the membrane forming material liquid (1) on outer peripheries thereof, serially from the inside. And then, the membrane forming material liquid (1) and the membrane forming material liquid (2) were coagulated in a coagulating liquid (liquid mixture of 8 parts by mass of N,N-dimethylacetamide and 92 parts by mass of water) maintained at 75° C., to thereby form a porous hollow fiber membrane precursor. It should be noted that, among the membrane forming material liquid (1) and the membrane forming material liquid (2) that were applied, a main material liquid that forms a membrane structure of the porous hollow fiber membrane precursor was the membrane forming material liquid (1) that was applied on the outside.

The porous hollow fiber membrane precursor was cleaned in hot water of 98° C. for 1 minute. Here, spinning speed (travel speed of the porous hollow fiber membrane precursor) was set at 20 m/min.

And then, the porous hollow fiber membrane precursor was caused to travel in pure water in such a way that an immersion duration was 3 minutes. And then, in an ozone processing unit (a container made of a SUS material) into which ozone gas of 9 vol % ozone concentration (mixture gas of ozone and oxygen; the same shall apply hereafter) was supplied at a rate of 0.35 L/min, the porous hollow fiber membrane precursor was brought into contact with ozone gas in a vapor phase, to thereby decompose the pore forming agent. Here, the porous hollow fiber membrane precursor was caused to travel in such a way that the processing time by ozone was 8 minutes. In addition, during the processing with the ozone gas, the porous hollow fiber membrane precursor was heated in contact with the ozone gas of 98° C. saturated with water, by supplying gas of 98° C. saturated with water along with the ozone gas.

And then, the porous hollow fiber membrane precursor was cleaned with pure water (the cleaning liquid) to remove the pore forming agent reduced in molecular weight by the decomposition, and a porous hollow fiber membrane was obtained. The porous hollow fiber membrane thus obtained was then dried and wound.

The porous hollow fiber membrane in which a porous membrane layer was formed on the outside of the reinforcing support body was thus obtained, the porous membrane layer having a gradient structure in which a high density layer of 0.2 μm in average pore diameter is present in the vicinity of external surface and the pore diameter increases as going inward.

### Examples 2 and 3

A porous hollow fiber membrane was obtained in the same way as in Example 1 by forming a porous hollow fiber membrane precursor, decomposing and removing a pore forming agent by ozone gas, and then drying, except for that the temperature of the gas saturated with water, with which the porous hollow fiber membrane precursor was brought into contact, was changed as shown in Table 2.

### Example 4

A porous hollow fiber membrane was obtained in the same way as in Example 1 by forming a porous hollow fiber membrane precursor, decomposing and removing a pore forming agent by ozone gas, and then drying, except for that the liquid (impregnating solution) to impregnate the porous hollow fiber membrane precursor was changed as shown in Table 2 and the temperature of the gas saturated with water, with which the porous hollow fiber membrane precursor was brought into contact, was changed as shown in Table 2.

### Comparative Example 1

The porous hollow fiber membrane precursor was prepared and cleaned in hot water as in Example 1. Thereafter, a porous hollow fiber membrane was obtained in the same way as Example 1, by cleaning to remove the solvent, decomposing to remove the pore forming agent, and drying, except for that the porous hollow fiber membrane precursor was caused to travel in 3 mass % aqueous solution of sodium hypochlorite (aqueous NaClO) instead of pure water, the precursor was not brought into contact with ozone gas, and the precursor was heated in contact with gas of 31° C. saturated with water.

### Comparative Example 2

The porous hollow fiber membrane precursor was prepared and cleaned in hot water as in Example 1. Thereafter, a porous hollow fiber membrane was obtained in the same way as Example 1, by cleaning to remove the solvent, decomposing to remove the pore forming agent, and drying, except for that the porous hollow fiber membrane precursor was caused to travel in ozone water of 30° C. in which ozone gas was bubbled in pure water, instead of bringing the porous hollow fiber membrane precursor into contact with ozone gas in a vapor phase.

### Comparative Example 3

A porous hollow fiber membrane was obtained by forming a porous hollow fiber membrane precursor in the same way as in Comparative Example 2, decomposing and removing a pore forming agent by ozone gas, and then drying, except for that the temperature of the ozone water, with which the porous hollow fiber membrane precursor was brought into contact, was changed as shown in Table 3.

### Comparative Example 4

The porous hollow fiber membrane precursor was prepared and cleaned in hot water as in Example 1. Thereafter, a porous hollow fiber membrane was obtained in the same way as Example 1, by cleaning to remove the solvent, decomposing to remove the pore forming agent, and drying, except for that the porous hollow fiber membrane precursor was heated in contact with ozone gas of 32° C. after drying the porous hollow fiber membrane precursor, instead of causing the porous hollow fiber membrane precursor to travel in pure water and bringing the porous hollow fiber membrane precursor into contact with ozone gas along with water-saturated gas.

### Comparative Example 5

A porous hollow fiber membrane was obtained by forming a porous hollow fiber membrane precursor in the same way as in Comparative Example 4, decomposing and removing a pore forming agent by ozone gas, and then drying, except for that the temperature of the ozone gas, with which the porous hollow fiber membrane precursor was brought into contact, was changed as shown in Table 4.

### [Water Filtration Performance (WF)]

The water filtration performance of the porous hollow fiber membrane was measured by the following method.

The undried porous hollow fiber membrane of 105 mm in length was picked and a flat tip stainless injection needle was inserted from a first end thereof into the hollow part, to 20 mm in depth. A hollow string of approximately 2 mm in diameter was wound at a position of 10 mm from a membrane end on an external peripheral surface of an insertion portion of the porous hollow fiber membrane in order to make close contact between an external periphery of the injection needle and an inner wall surface of the hollow part of the porous hollow fiber membrane, and both ends of the hollow string were fixed in a state in which a tensile force of approximately 1 to 5 N was applied to the hollow string. And then, an open end of a second end of the porous hollow fiber membrane was clamped to close the hollow part. A position of clamping was set such that a distance between a position where the hollow string was wound and a point of closure on the porous hollow fiber membrane was 40 mm. Thereafter, pure water was press-fitted through the injection needle into the hollow part of the porous hollow fiber membrane. Injection pressure of pure water was controlled such that the pressure was 0.1 MPa at a position of 15 mm from a base of the injection needle. 1 minute after beginning of injection of pure water, membrane outflow water was collected for 1 minute and the mass thereof was measured. Temperature of the membrane outflow water was measured and converted to the water filtration performance at a reference temperature (25° C.) according to the following equation (I).

$$\begin{matrix}[ Equation 1 ] & \\ {WF}_{1} = \frac{{μ}_{2}}{{μ}_{1}} {WF}_{2} & ( I )\end{matrix}$$

Symbols in Equation (I) have the following meanings:

WF₁: Water filtration performance [g/min] when the temperature of the membrane outflow water is T₁;

WF₂: Water filtration performance [g/min] when the temperature of the membrane outflow water is T₂;

μ₁: Viscosity of water [Pa·s] at temperature T₁; and

μ₂: Viscosity of water [Pa·s] at temperature T₂.

Equation (I) was derived from Hagen-Poiseuille's law (represented by the following Equation (II)) that describes a relationship among a flow rate, viscosity, and pressure loss of fluid in a tube during laminar flow.

$$\begin{matrix}[ Equation 2 ] & \\ Δ P = 128 \frac{QL μ}{π {D}^{4}} & ( II )\end{matrix}$$

Symbols in Equation (II) have the following meanings:

ΔP: Pressure loss [Pa];

L: Tube length [m];

D: Tube diameter [m];

p: Fluid viscosity [Pa·s]; and

Q: Flow rate at tube cross section [m³·s⁻¹].

Since the flow rate Q of the above Equation (II) is proportional to WF, Equation (II) is converted by a factor into Equation (III) below. Supposing that a porous part on a surface of the membrane is a collective body of flexed tubes, WF is proved to be proportional to the viscosity when ΔP is constant.

$$\begin{matrix}[ Equation 3 ] & \\ Δ P = α \frac{WF \cdot L μ}{π {D}^{4}} & ( III )\end{matrix}$$

It should be noted that α in the above Equation (III) represents the factor [-].

At measured temperatures T₁ and T₂, the above Equation (III) gives the following Equations (IV-a) and (IV-b).

$$\begin{matrix}[ Equation 4 ] & \\ Δ {P}_{1} = α \frac{{WF}_{1} \cdot {L}_{1} {μ}_{1}}{π {D}_{1}^{4}} & ( IV \text{-} a ) \\ Δ {P}_{2} = α \frac{{WF}_{2} \cdot {L}_{2} {μ}_{2}}{π {D}_{2}^{4}} & ( IV \text{-} b )\end{matrix}$$

Since the differential pressure upon measurement of WF is constant, ΔP₁=ΔP_{E}. Since the shape of passage is unchanged in the same membrane, L₁=L₂ and D₁=D₂. Dividing both sides of the above Equations (IV-a) and (IV-b) based on this derives the above Equation (I).

The viscosity of water at the temperature T [° C.] was obtained according to the JIS method (JIS Z 8803).

Results of measurement of water filtration performance of the porous hollow fiber membranes of Examples and Comparative Examples are shown in Tables 2 to 4.

TABLE 2

| | | | | | | | | 25° C.- |
|---|---|---|---|---|---|---|---|---|
| | | Ozone gas | | | Temper- | WF | | converted |
| | | Ozone | | Process- | ature | measured | Water | water |
| | Impreg- | concen- | Supply | ing | of water | temper- | filtration | filtration |
| | nating | tration | amount | time | saturated | ature | performance | performance |
| | solution | [vol %] | [L/min] | [min] | gas [° C.] | [° C.] | [g/min] | [g/min] |
| Example 1 | Pure | 9 | 0.35 | 8 | 98 | 15.7 | 40.0 | 50.2 |
| | water | | | | | | | |
| Example 2 | Pure | 9 | 0.35 | 8 | 61 | 17.0 | 44.8 | 54.4 |
| | water | | | | | | | |
| Example 3 | Pure | 9 | 0.35 | 8 | 31 | 10.0 | 24.7 | 36.2 |
| | water | | | | | | | |
| Example 4 | Acetic | 9 | 0.35 | 8 | 99 | 32.8 | 64.6 | 53.8 |
| | acid | | | | | | | |
| Comparative | Aqueous | — | — | 8 | 31 | 29.0 | 1.8 | 1.6 |
| Example 1 | NaClO | | | | | | | |

TABLE 3

| | | | | | | | | 25° C.- |
|---|---|---|---|---|---|---|---|---|
| | | Ozone gas | | | Temper- | WF | | converted |
| | | Ozone | | Process- | ature | measured | Water | water |
| | Impreg- | concen- | Supply | ing | of water | temper- | filtration | filtration |
| | nating | tration | amount | time | saturated | ature | performance | performance |
| | solution | [vol %] | [L/min] | [min] | gas [° C.] | [° C.] | [g/min] | [g/min] |
| Comparative | Pure | 9 | 0.35 | 8 | 30 | 34.3 | 9.8 | 8.0 |
| Example 2 | water | | | | | | | |
| Comparative | Pure | 9 | 0.35 | 8 | 98 | 34.0 | 5.3 | 4.3 |
| Example 3 | water | | | | | | | |

TABLE 4

| | | | | | | | | 25° C.- |
|---|---|---|---|---|---|---|---|---|
| | | Ozone gas | | | Temper- | WF | | converted |
| | | Ozone | | Process- | ature | measured | Water | water |
| | Impreg- | concen- | Supply | ing | of water | temper- | filtration | filtration |
| | nating | tration | amount | time | saturated | ature | performance | performance |
| | solution | [vol %] | [L/min] | [min] | gas [° C.] | [° C.] | [g/min] | [g/min] |
| Comparative | — | 9 | 0.35 | 8 | 32 | 33.6 | 0.0 | 0.0 |
| Example 4 | | | | | | | | |
| Comparative | — | 9 | 0.35 | 8 | 97 | 34.0 | 0.0 | 0.0 |
| Example 5 | | | | | | | | |

As shown in Tables 2 to 4, in Examples 1 to 3 that brought the porous hollow fiber membrane precursors including water into contact with ozone gas in a vapor phase, the porous hollow fiber membranes have higher water filtration performance, and the pore forming agent remaining in the membrane was more sufficiently decomposed and removed, compared to Comparative Examples 2 and 3 (Table 3) that caused the porous hollow fiber membrane precursors in the ozone water in which ozone gas was bubbled in pure water, and Comparative Examples 4 and 5 (Table 4) that brought the porous hollow fiber membrane precursors in a dry state into contact with ozone gas.

In addition, while Comparative Example 1 that employed sodium hypochlorite and not ozone gas could not sufficiently decompose and remove the pore forming agent by the process at the temperature of 31° C., Example 3 successfully decomposed and removed the pore forming agent remaining in the porous hollow fiber membrane precursor by the process at the same temperature. Example 4, which employed acetic acid in place of water as a liquid to impregnate the porous hollow fiber membrane precursor, also successfully decomposed and removed the pore forming agent remaining in the porous hollow fiber membrane precursor.

### Example 5

The porous hollow fiber membrane precursor was prepared and cleaned in hot water as in Example 1. And then, the porous hollow fiber membrane precursor was caused to travel in sodium hypochlorite solution (aqueous NaClO, at 20° C.) of 30,000 mg/L in effective chlorine concentration, in such a way that an immersion duration was 3 minutes. And then, in an ozone processing unit (a container made of a SUS material) into which ozone gas of 9 vol % ozone concentration was supplied at a rate of 0.35 L/min, the porous hollow fiber membrane precursor was brought into contact with ozone gas in a vapor phase, to thereby decompose the pore forming agent. Here, the porous hollow fiber membrane precursor was caused to travel in such a way that the processing time by ozone was 1 minutes. In addition, during the processing with the ozone gas, the porous hollow fiber membrane precursor was heated in contact with the ozone gas of 97° C. saturated with water, by supplying gas of 97° C. saturated with water along with the ozone gas.

The porous hollow fiber membrane in which a porous membrane layer was formed on the outside of the reinforcing support body was thus obtained, the porous membrane layer having a gradient structure in which a high density layer of 0.2 μm in average pore diameter is present in the vicinity of external surface and the pore diameter increases as going inward.

### Example 6

The porous hollow fiber membrane precursor was prepared and cleaned in hot water as in Example 1.

Thereafter, a porous hollow fiber membrane was obtained in the same way as Example 5, by cleaning to remove the solvent, decomposing to remove the pore forming agent, and drying, except for that the porous hollow fiber membrane precursor was caused to travel in an aqueous solution of hydrogen peroxide (H₂O₂, 3 mass %) instead of the above described aqueous solution of sodium hypochlorite, and the temperature of the gas saturated with water was changed as shown in Table 5.

### Comparative Example 6

The porous hollow fiber membrane precursor was prepared and cleaned in hot water as in Example 1.

A porous hollow fiber membrane was obtained in the same way as in Example 5 by forming a porous hollow fiber membrane precursor, decomposing and removing a pore forming agent by ozone gas, and then drying, except for that the porous hollow fiber membrane precursor was not brought into contact with ozone gas and the temperature of the gas saturated with water was changed as shown in Table 5.

### Comparative Example 7

The porous hollow fiber membrane precursor was prepared and cleaned in hot water as in Example 1.

Thereafter, a porous hollow fiber membrane was obtained in the same way as Example 5, by cleaning to remove the solvent, decomposing to remove the pore forming agent, and drying, except for that the porous hollow fiber membrane precursor was caused to travel in an aqueous solution of hydrogen peroxide (3 mass %) instead of the above described aqueous solution of sodium hypochlorite, the porous hollow fiber membrane precursor was not brought into contact with ozone gas, and the temperature of the gas saturated with water was changed as shown in Table 5.

### Reference Example

The porous hollow fiber membrane precursor was prepared and cleaned in hot water as in Example 1.

Thereafter, a porous hollow fiber membrane was obtained in the same way as Example 5, by cleaning to remove the solvent, decomposing to remove the pore forming agent, and drying, except for that the porous hollow fiber membrane precursor was caused to travel in pure water instead of the above described aqueous solution of sodium hypochlorite, and the temperature of the gas saturated with water was changed as shown in Table 5.

Results of measurement of water filtration performance of the porous hollow fiber membranes of Examples and Comparative Examples are shown in Table 5.

TABLE 5

| | | | Ozone processing unit | | | | | | |
|---|---|---|---|---|---|---|---|---|---|
| | Oxidizing agent | | | | | Temper- | | | 25° C.- |
| | supply unit | | | | | ature | WF | | converted |
| | | Immer- | Ozone | | Process- | of water | measured | Water | water |
| | | sion | concen- | Supply | ing | saturated | temper- | filtration | filtration |
| | | time | tration | amount | time | gas | ature | performance | performance |
| | Type | [min] | [vol %] | [L/min] | [min] | [° C.] | [° C.] | [g/min] | [g/min] |
| Example 5 | Aqueous | 3 | 9 | 0.35 | 1 | 97 | 18.0 | 44.7 | 52.9 |
| | NaClO | | | | | | | | |
| Example 6 | Aqueous | 3 | 9 | 0.35 | 1 | 99 | 21.1 | 17.8 | 19.5 |
| | H₂O₂ | | | | | | | | |
| Comparative | Aqueous | 3 | — | — | 1 | 100 | 18.0 | 10.8 | 12.8 |
| Example 6 | NaClO | | | | | | | | |
| Comparative | Aqueous | 3 | — | — | 1 | 98 | 18.5 | 3.1 | 3.6 |
| Example 7 | H₂O₂ | | | | | | | | |
| Reference | Pure | 3 | 9 | 0.35 | 1 | 98 | 18.0 | 9.6 | 11.3 |
| Example | water | | | | | | | | |

As shown in Table 5, Examples 5 and 6 that employed a combination of ozone gas and the other oxidizing agent provided the porous hollow fiber membranes of higher water filtration performance, and more sufficiently decomposed and removed the pore forming agent remaining in the membrane, compared to Comparative Examples 6 and 7 that employed ozone gas or the other oxidizing agent singly.

In addition, the water filtration performance of the porous hollow fiber membrane of Example 5 that employed the combination of sodium hypochlorite and ozone gas was higher than a sum of water filtration performance of the porous hollow fiber membranes of Comparative Example 6 and Reference Example that respectively employed sodium hypochlorite and ozone gas singly, proving that combining sodium hypochlorite with ozone gas improves the water filtration performance substantially.

### INDUSTRIAL APPLICABILITY

The method for manufacturing a porous hollow fiber membrane of the present invention, which can reduce the equipment and facility costs for the removal process of pore forming agent and can facilitate waste water disposal after the process, can preferably be used for manufacturing of various porous hollow fiber membranes for water treatment and the like.

### EXPLANATION OF REFERENCE NUMERALS

10 Spinning nozzle
12 Coagulating means
12a Coagulating liquid
12b Coagulation bath
14 Cleaning means
14a Cleaning liquid
14b Cleaning bath
16 Removing means
16a Ozone processing unit
16b Cleaning liquid
16c Cleaning bath
16d Oxidizing agent solution
16e Oxidizing agent supply unit
18 Drying means
20 Winding means
22 Guide members

1. A method of manufacturing a porous hollow fiber membrane, the method comprising:
coagulating a membrane forming material liquid comprising a membrane forming resin and a pore forming agent by a coagulating liquid, to thereby form a porous hollow fiber membrane precursor; and
removing the porous hollow fiber membrane precursor impregnated at least with a liquid in contact with ozone gas in a vapor phase, to thereby decompose and remove the pore forming agent present in the membrane.

2. The method of claim 1, wherein the porous hollow fiber membrane precursor is impregnated with an oxidizing agent, which is other than ozone, and the liquid is contacted with the ozone gas in the vapor phase.

3. The method of claim 2, wherein the oxidizing agent is sodium hypochlorite.

4. The method of claim 2, wherein the oxidizing agent is hydrogen peroxide.

5. The method of claim 1, wherein the liquid is water.

6. The method of claim 2, wherein the liquid is water.
